(19) United States
(12) Patent Application Publication
(10) Pub. No.: US 2024/0402906 A1
(43) Pub. Date: Dec. 5, 2024

(54) SCREEN CONTROL METHOD, USER INTERFACE DEVICE, AND IMAGE PROCESSING APPARATUS

(71) Applicant: KYOCERA Document Solutions Inc., Osaka (JP)

(72) Inventors: Ken Saratani, Osaka-shi (JP); Toshiya Miyai, Osaka-shi (JP)

(21) Appl. No.: 18/678,231

(22) Filed: May 30, 2024

(30) Foreign Application Priority Data
Jun. 2, 2023 (JP) 2023-091962

(51) Int. Cl. G06F 3/04886; G06F 3/041; H04N 1/00

(52) U.S. Cl. CPC G06F 3/04886; G06F 3/0416; H04N 1/00411; G06F 2203/04803; G06F 2203/04804

(57) ABSTRACT

When a touch operation on a transition operation image on an original screen is detected in a pop-up state where the original screen and a pop-up screen are displayed on a touch panel unit, the processor causes the touch panel unit to display a transition destination screen while maintaining a display of the pop-up screen. When a touch operation on a specific operation image on the original screen is detected in the pop-up state, the processor closes the pop-up screen and causes the touch panel unit to display a specific screen. When a specific screen end event occurs, the processor returns a display state of the touch panel unit to the pop-up state.

### INCORPORATION BY REFERENCE

This application is based upon and claims the benefit of priority from the corresponding Japanese Patent Application No. 2023-091962 filed on Jun. 2, 2023, the entire contents of which are incorporated herein by reference.

### BACKGROUND

The present disclosure relates to a screen control method for controlling a display screen of a touch panel unit, a user interface device, and an image processing apparatus.

Image processing apparatuses such as copying machines or multifunction peripherals often include a touch panel unit. The image processing apparatus displays various types of menu screens on the touch panel unit.

The image processing apparatus may display a pop-up screen including notification information over a part of the menu screen when a notification event occurs. Thus, the notification information is provided within a field of view of a user.

In addition, it is known that an image forming apparatus changes transmittance of the pop-up screen depending on the situation.

### SUMMARY

A screen control method according to an aspect of the present disclosure is a method for controlling a display screen of a touch panel unit. The screen control method includes a processor causing the touch panel unit to display an original screen including a plurality of operation images, each of which receives a touch operation. In addition, the screen control method includes the processor causing a pop-up screen including notification information to be displayed over a part of the original screen when a notification event occurs while the original screen is being displayed on the touch panel unit. Moreover, the screen control method includes the processor, when a touch operation on a transition operation image that is a part of the plurality of operation images on the original screen is detected in a pop-up state where the original screen and the pop-up screen are displayed on the touch panel unit, causing the touch panel unit to display a transition destination screen corresponding to the transition operation image in place of the original screen while maintaining the display of the pop-up screen. Furthermore, the screen control method includes the processor, when a touch operation on a specific operation image that is part of the plurality of operation images on the original screen is detected in the pop-up state, closing the pop-up screen and causing the touch panel unit to display a specific screen corresponding to the specific operation image in place of the original screen or over a part of the original screen. In addition, the screen control method includes the processor returning a display state of the touch panel unit to the pop-up state when a specific screen end event indicating an end of a process corresponding to the specific screen occurs.

A user interface device according to another aspect of the present disclosure includes a touch panel unit; and a processor configured to implement the screen control method.

An image processing apparatus according to another aspect of the present disclosure includes the user interface device, and an image processing portion configured to execute image processing set by operations on the user interface device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of an image processing apparatus according to an embodiment.

FIG. 2 is a flowchart illustrating an example of a screen output control procedure in an image processing apparatus according to an embodiment.

FIG. 3 is a flowchart illustrating an example of a pop-up control procedure in an image processing apparatus according to an embodiment.

FIG. 4 is a flowchart illustrating an example of a key input control procedure in an image processing apparatus according to an embodiment.

FIG. 5 is a flowchart illustrating an example of a mark display control procedure in an image processing apparatus according to an embodiment.

FIG. 6 is a diagram illustrating an example of a menu screen in a normal state in an image processing apparatus according to an embodiment.

FIG. 7 is a diagram illustrating an example of a menu screen in a pop-up state in an image processing apparatus according to an embodiment.

FIG. 8 is a diagram illustrating an example of a menu screen in a notification mark display state in an image processing apparatus according to an embodiment.

FIG. 9 is a diagram illustrating an example of a key input screen in an image processing apparatus according to an embodiment.

FIG. 10 is a diagram illustrating an example of a key input screen including a notification mark in an image processing apparatus according to an embodiment.

### DETAILED DESCRIPTION

Embodiments according to the present disclosure will be described below with reference to the drawings. Note that the following embodiments are examples that embody a technique according to the present disclosure, and do not limit the technical scope of the present disclosure.

### [Image Processing Apparatus 10]

The image processing apparatus 10 according to an embodiment is capable of executing various types of image processing such as an image forming process, an image reading process, and an image transmission process. For example, the image processing apparatus 10 is a printer, a copying machine, a facsimile apparatus, a multifunction peripheral, or the like.

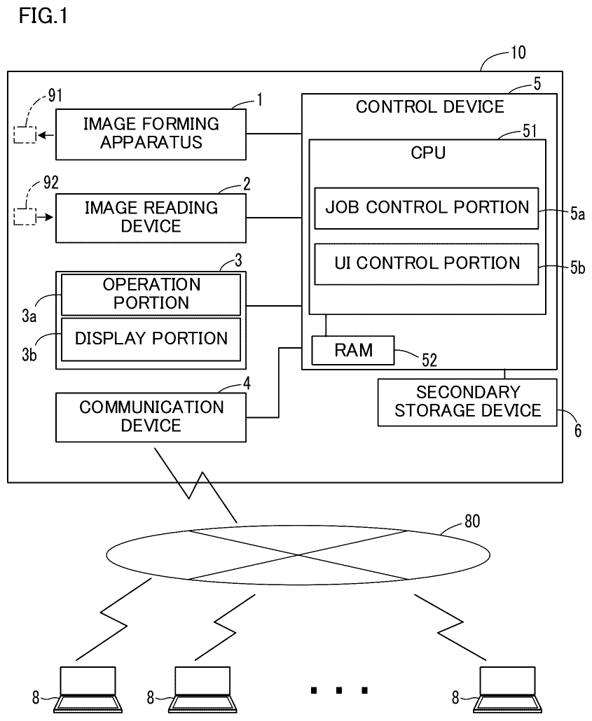

In the example shown in FIG. 1, the image processing apparatus 10 includes an image forming apparatus 1, an image reading device 2, a touch panel unit 3, a communication device 4, a control device 5, and a secondary storage device 6.

The image processing apparatus 10 can communicate with other devices such as a host device 8 through a network 80. The network 80 includes a local area network (LAN), the Internet, and the like.

The image forming apparatus 1 executes the image forming process using a predetermined method such as an electrophotographic method or an inkjet method. The image forming process is a process of forming an image on a sheet 91.

The image forming apparatus 1 includes a sheet conveying mechanism that conveys a sheet 91 and a printing device that forms an image on the sheet 91.

The image reading device 2 executes the image reading process. The image reading process is a process of reading an image from a document 92. The image reading device 2 includes an optical scanning mechanism that scans the document 92 with light, and an image sensor that receives the reflected light reflected from the document 92.

The image sensor outputs data of a read image. The read image is an image read from the document 92.

Touch panel unit 3 includes an operation portion 3a and a display portion 3b. The operation portion 3a has an operation panel that receives touch operations performed by a person. The display portion 3b is a display panel that is capable of displaying information. The operation portion 3a detects a touch operation on the surface of the display portion 3b.

The communication device 4 is a communication interface device that communicates with other devices such as the host device 8 through the network 80. The control device 5 performs all data transmission and reception with the other devices through the communication device 4.

The image forming apparatus 1 executes the image forming process based on the read image data or received printing data. The received print data is data included in a printing request received from the host device 8 via the communication device 4.

Furthermore, the communication device 4 is capable of executing the image transmission process. The image transmission process is a process of transmitting the data of the read image to a specified destination via the network 80.

The control device 5 executes various types of calculations, data processing, and control of various types of electrical devices included in the image processing apparatus 10. The control device 5 includes a CPU 51, a random access memory (RAM) 52, and the like.

The secondary storage device 6 is a computer-readable non-volatile storage device. The secondary storage device 6 is able to store computer programs and various types of data. For example, one or both of a solid state drive (SSD) and a hard disk drive may be employed as the secondary storage device 6.

The secondary storage device 6 stores a computer program executed by the CPU 51 and data referenced by the CPU 51. The CPU 51 is an example of a processor.

The CPU 51 is a processor that executes various types of data processing and control by executing the computer program stored in the secondary storage device 6.

It is also conceivable that another processor such as a DSP may execute data processing and control instead of the CPU 51.

The RAM 52 is a computer readable volatile storage device. The RAM 52 temporarily stores the computer program executed by the CPU 51 and data output and referenced during the process of the CPU 51 executing the computer program.

The CPU 51 includes a plurality of processing modules achieved by executing the computer program. The plurality of processing modules in the CPU 51 include a job control portion 5a, a UI control portion 5b, and the like.

The job control portion 5a causes each device of the image processing apparatus 10 to execute the image processing corresponding to a request input via the operation portion 3a or the communication device 4.

The job control portion 5a controls the image forming apparatus 1, the image reading device 2, and the communication device 4. The job control portion 5a causes some or all of the image forming apparatus 1, image reading device 2, and communication device 4 to execute the requested image processing.

The image forming apparatus 1, the image reading device 2, and the communication device 4 are examples of image processing portions capable of executing the image processing set by operating the touch panel unit 3. In the present embodiment, the image processing includes the image forming process, the image reading process, and the image transmission process.

The UI control portion 5b controls the touch panel unit 3. In the screen control, the UI control portion 5b selects a target screen from a plurality of candidate screens according to an operation on the operation portion 3a, and displays the selected target screen on the display portion 3b. The touch panel unit 3 and the UI control portion 5b are examples of a user interface device.

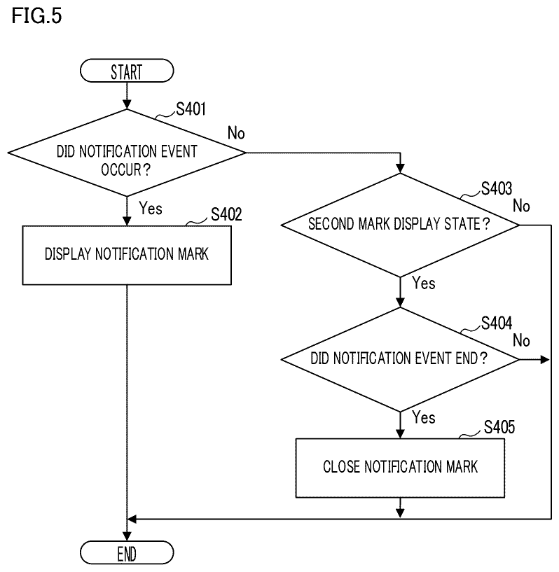

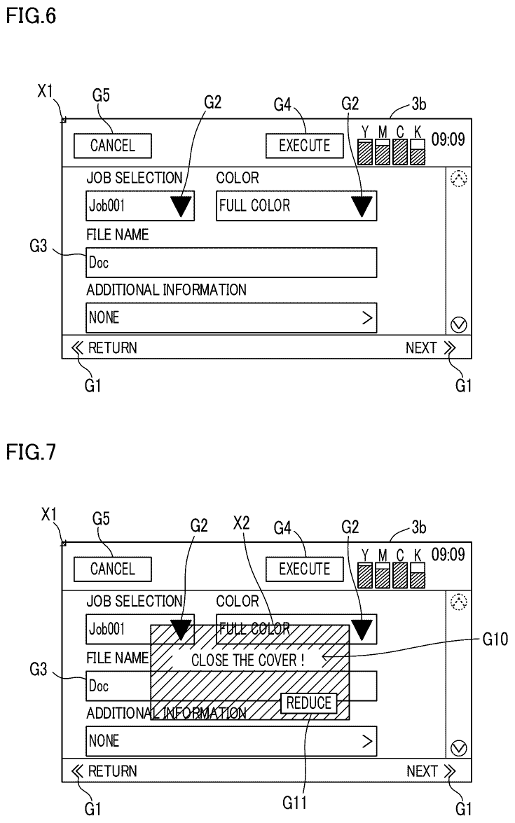

For example, the target screen is a menu screen X1 that receives an operation for setting a process to be executed by the image processing apparatus 10 for each of a plurality of functions of the image processing apparatus 10 (see FIG. 6).

For example, the menu screen X1 includes a plurality of operation icons G1 to G5. The plurality of operation icons G1 to G5 are examples of a plurality of operation images that receive a touch operation.

For example, the plurality of operation icons G1 to G5 include a transition icon G1, a selection icon G2, a key input icon G3, an execution icon G4, a setting cancellation icon G5, and the like.

The transition icon G1 receives a transition operation that instructs a process to transition the display state of the screen of the display portion 3b from the original menu screen X1 to another screen. When the transition operation is detected, the UI control portion 5b causes the display portion 3b to display a screen corresponding to the operated transition icon G1 instead of the original menu screen X1. The transition operation is a touch operation on the transition icon G1.

The selection icon G2 receives a selection operation to select one or more of a plurality of selection options. For example, the plurality of selection options are a plurality of candidates for a processing parameter such as an image processing condition. The UI control portion 5b sets the value of the processing parameter according to the selection operation. The selection operation is a touch operation on the selection icon G2.

The key input icon G3 receives a keyboard call operation. The UI control portion 5b causes the display portion 3b to display the key input screen X3 when the keyboard call operation is detected (see FIG. 9). The keyboard call operation is a touch operation on the key input icon G3.

The key input screen X3 receives input operations for text data. The key input screen X3 is larger than the pop-up screen X2.

The key input screen X3 includes a virtual keyboard G20 and a text frame G21. The text frame G21 is a portion where text input by a touch operation on the virtual keyboard G20 is displayed.

The key input screen X3 further includes a confirmation icon G22 and an input cancellation icon G23. That is, the UI control portion 5b includes the confirmation icon G22 and the input cancellation icon G23 in the key input screen X3.

The confirmation icon G22 receives a confirmation operation to confirm the text input by a touch operation on the virtual keyboard G20 as the text data. The confirmation operation is a touch operation on the confirmation icon G22.

In the example shown in FIG. 9, the return key of the virtual keyboard G20 is the confirmation icon G22. When the confirmation operation is detected, the UI control portion 5b confirms the text displayed in the text frame G21 as the text data, and closes the key input screen X3.

When the confirmation operation is detected, the UI control portion 5b sets the text data as the value of the processing parameter corresponding to the key input icon G3.

The input cancellation icon G23 accepts an input cancellation operation to cancel inputting the text data using the virtual keyboard G20. The UI control portion 5b closes the key input screen X3 when the input cancellation operation is detected.

The confirmation icon G22 and the input cancellation icon G23 are examples of specific end images that each receive an operation to instruct the end of the specific operation corresponding to the key input screen X3. The operation of inputting the text data is an example of the specific operation. The detection event of the confirmation operation or the input cancellation operation by the operation portion 3a is an example of a specific screen end event indicating the end of the process corresponding to the key input screen X3.

The execution icon G4 receives an execution operation that instructs execution of the image processing. When the execution operation is detected, the UI control portion 5b passes the specified conditions set according to the selection operation and the operation on the key input screen X3 to the job control portion 5a. Thus, the job control portion 5a causes the image processing portion to execute the image processing according to the specified conditions. The execution operation is a touch operation on the execution icon G4.

The setting cancellation icon G5 receives a setting cancellation operation that instructs to cancel the settings related to the image processing corresponding to the menu screen X1. When the setting cancellation operation is detected, the UI control portion 5b causes the display unit 3b to display a main menu screen (not shown) as the menu screen X1. The setting cancellation operation is a touch operation on the setting cancellation icon G5.

Furthermore, when a notification event occurs, the UI control portion 5b displays a pop-up screen X2, including notification information G10, over a part of the menu screen X1 (see FIG. 7). Thus, the notification information G10 is provided so as to be reliably within the field of view of the user.

For example, the notification event occurs when a sensor included in the image processing apparatus 10 detects a predetermined notification required state. In addition, the notification event ends when the sensor does not detect the notification state.

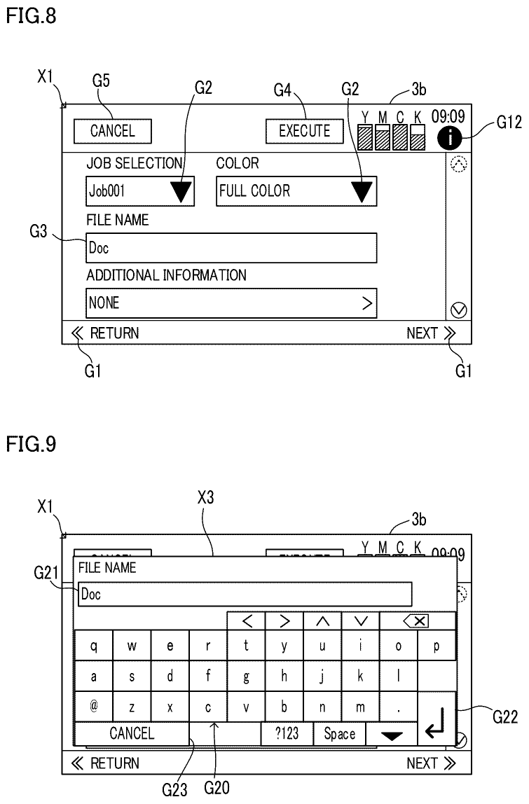

In the present embodiment, the pop-up screen X2 further includes a reduction icon G11 (see FIG. 7). The reduction icon G11 receives an operation to instruct a process to display a notification mark G12 instead of the pop-up screen X2 (see FIG. 8).

When the touch operation on the reduction icon G11 is detected, the UI control portion 5b closes the pop-up screen X2 and displays the notification mark G12 in a part of the menu screen X1 (see FIG. 8).

The notification mark G12 is an image smaller than the pop-up screen X2. The notification mark G12 indicates that a state of being notified of notification information G10 has not been resolved. The notification mark G12 is an example of a simple notification image.

The pop-up screen X2 is closed from the screen of the touch panel unit when a confirmation operation indicating confirmation of the notification information G10 is detected. A touch operation on the reduction icon G11 is an example of a confirmation operation.

On the other hand, operations on the icons included in the menu screen X1 are valid in areas other than the pop-up screen X2 on the menu screen X1.

Generally, in a case where a separate screen is displayed by operating the transition icon G1 on the menu screen X1, the display of the pop-up screen X2 is maintained. In a case where the user wants to confirm the separate screen with priority over the pop-up screen X2, the user needs to perform the confirmation operation before or after the separate screen is displayed.

However, it is desirable to be able to close the pop-up screen X2 with as few operations as possible while avoiding failure to confirm the notification information G10.

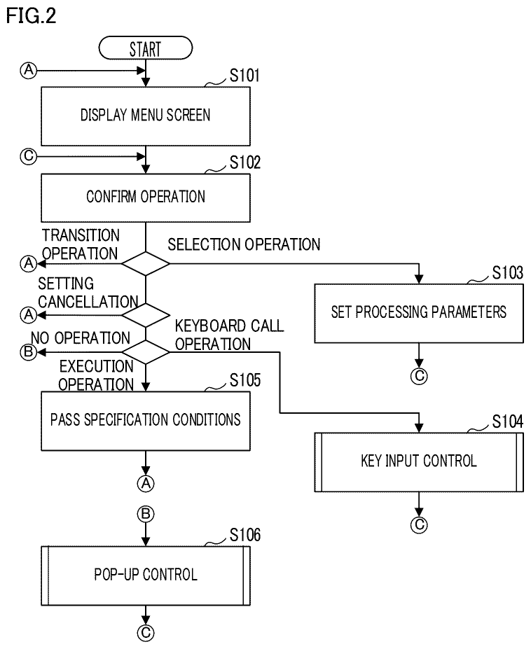

The UI control portion 5b executes screen output control to be described later (see FIG. 2). In a case where a new screen is displayed due to an operation on the menu screen X1 while the pop-up screen X2 is displayed, the screen output control includes processing for closing the pop-up screen X2 with as few operations as possible while avoiding failure to confirm the notification information G10.

The screen output control is an example of processing that achieves a screen control method for controlling the display screen of the touch panel unit 3. The CPU 51 that executes the screen output control is an example of a processor that achieves the screen control method.

### [Screen Output Control]

An example of the screen output control procedure will be described below with reference to the flowchart shown in FIG. 2.

The UI control portion 5b executes the screen output control when the image processing apparatus 10 is started or when an operation instructing the display portion 3b to display the menu screen X1 is performed on the operation portion 3a.

In the following description, S101, S102, and so on represent identification codes of a plurality of steps in the screen output control. In the screen output control, first, the process of step S101 is executed.

### <Step S101>

In step S101, the UI control portion 5b selects the menu screen X1 from the plurality of candidate screens, and causes the display portion 3b to display the selected menu screen X1. FIG. 6 shows an example of the menu screen X1.

The menu screen X1 is an example of an original screen including the plurality of operation images, each of which receives a touch operation. After executing the process of step S101, the UI control portion 5b executes the process of step S102.

### <Step S102>

In step S102, the UI control portion 5b confirms the status of the operation on the operation portion 3a. Furthermore, the UI control portion 5b selects the next process to be executed depending on the status of the operation on the operation portion 3a.

When the transition operation on the operation portion 3a is detected, the UI control portion 5b executes the process of step S101. In this case, in step S101, the UI control portion 5b causes the display portion 3b to display a new menu screen X1 corresponding to the transition operation.

The UI control portion 5b also executes the process of step S101 when the setting cancellation operation on the operation portion 3a is detected. In this case, in step S101, the UI control portion 5b causes the display portion 3b to display a main menu screen (not shown) as a new menu screen X1.

When the selection operation on the operation portion 3a is detected, the UI control portion 5b executes the process of step S103.

When the keyboard call operation on the operation portion 3a is detected, the UI control portion 5b executes the process of step S104.

When the execution operation on the operation portion 3a is detected, the UI control portion 5b executes the process of step S105.

When no operation on the operation portion 3a is detected, the UI control portion 5b executes the process of step S106.

### <Step S103>

In step S103, the UI control portion 5b sets the value of the processing parameter according to the selection operation.

After executing the process of step S103, the UI control portion 5b executes the process of step S102 again.

### <Step S104>

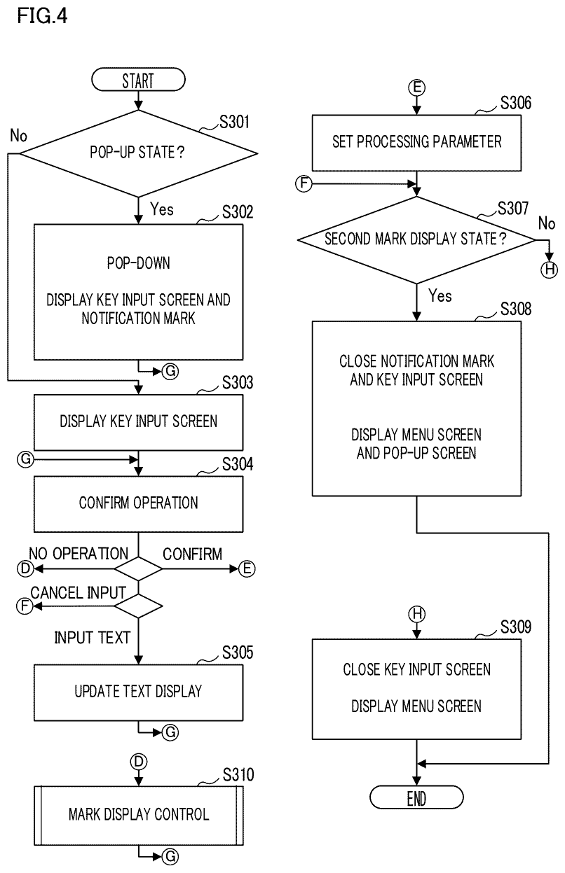

In step S104, the UI control portion 5b executes key input control to be described later (see FIG. 4).

After executing the process of step S104, the UI control portion 5b executes the process of step S102 again.

### <Step S105>

In step S105, the UI control portion 5b executes key input control to be described later (see FIG. 4). The key input control is a process related to the key input screen X3.

After executing the process of step S105, the UI control portion 5b executes the process of step S101 again.

### <Step S106>

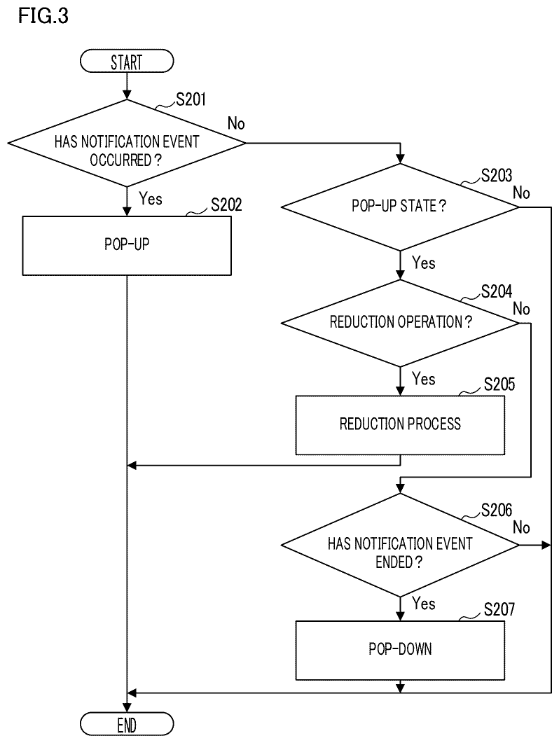

In step S106, the UI control portion 5b executes pop-up control to be described later (see FIG. 3). The pop-up control is a process related to the pop-up screen X2.

After executing the process of step S106, the UI control portion 5b executes the process of step S102 again.

### [Pop-Up Control]

Next, an example of the pop-up control procedure executed in step S106 will be described with reference to the flowchart shown in FIG. 3.

In the following description, S201, S202, and so on represent identification codes of a plurality of steps in the pop-up control. In the pop-up control, first, the process of step S201 is executed.

### <Step S201>

In step S201, the UI control portion 5b selects a process to be executed depending on whether or not the notification event has occurred.

The UI control portion 5b executes the process of step S202 when the notification event has occurred. On the other hand, the UI control portion 5b executes the process of step S203 when the notification event has not occurred.

### <Step S202>

In step S202, the UI control portion 5b executes a pop-up process to display the pop-up screen X2 over a part of the menu screen X1 (see FIG. 7).

The menu screen X1 displayed on the display portion 3b in step S201 is an example of the original screen. The process in step S202 is executed when the notification event occurs while the menu screen X1 is being displayed on the display portion 3b (see step S201).

After executing the process of step S202, the UI control portion 5b ends the pop-up control.

### <Step S203>

In step S203, the UI control portion 5b selects a process to be executed depending on whether or not the display portion 3b is in a pop-up state. The pop-up state is a state in which the menu screen X1 and the pop-up screen X2 are displayed on the display portion 3b.

The UI control portion 5b executes the process of step S204 in a case where the state of the display portion 3b is the pop-up state. On the other hand, the UI control portion 5b ends the pop-up control in a case where the state of the display portion 3b is not the pop-up state.

### <Step S204>

In step S204, the UI control portion 5b selects a process to be executed depending on whether or not the reduction operation on the operation portion 3a is detected.

The UI control portion 5b executes the process of step S205 in a case where the reduction operation on the operation portion 3a is detected. On the other hand, the UI control portion 5b executes the process of step S206 in a case where the reduction operation is not detected.

### <Step S205>

In step S205, the UI control portion 5b executes a reduction process to display the notification mark G12 on the display portion 3b instead of the pop-up screen X2 (see FIG. 8).

That is, in the reduction process, the UI control portion 5b closes the pop-up screen X2 and displays the notification mark G12 in a part of the menu screen X1.

In the following description, a state where the menu screen X1 and the notification mark G12 are displayed and the key input screen X3 is not displayed will be referred to as a first mark display state (see FIG. 8). After executing the process of step S205, the UI control portion 5b ends the pop-up control.

### <Step S206>

In step S206, the UI control portion 5b selects a process to be executed depending on whether or not the notification event has ended.

The UI control portion 5b executes the process of step S207 in a case where the notification event has ended. On the other hand, the UI control portion 5b ends the pop-up control in a case where the notification event has not ended.

### <Step S207>

In step S207, the UI control portion 5b executes a pop-down process to close the pop-up screen X2 from the display unit 3b.

By executing the pop-down process, the pop-up screen X2 is closed while the menu screen X1 remains displayed (see FIG. 6).

After executing the process of step S207, the UI control portion 5b ends the pop-up control.

The notification mark G12 when the display portion 3b is in the first mark display state is an operation icon that receives a pop-up operation.

When the pop-up operation is detected in a situation where the state of the display portion 3b is in the first mark display state, the UI control portion 5b closes the notification mark G12 and executes the pop-up process (not shown). The pop-up operation is a touch operation on the notification mark G12.

### [Key Input Control]

Next, an example of the key input control procedure executed in step S104 will be described with reference to the flowchart shown in FIG. 4.

In the following description, S301, S302, and so on represent identification codes of a plurality of steps in the key input control. In the key input control, first, the process of step S301 is executed.

### <Step S301>

In step S301, the UI control portion 5b selects a process to be executed depending on whether or not the state of the display portion 3b is in the pop-up state.

The UI control portion 5b executes the process of step S302 in a case where the state of the display portion 3b is the pop-up state. On the other hand, the UI control portion 5b executes the process of step S303 in a case where the state of the display portion 3b is not the pop-up state.

### <Step S302>

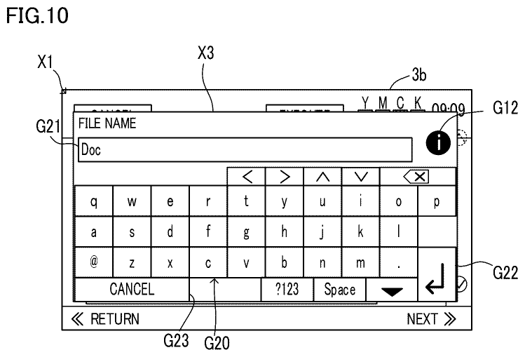

In step S302, the UI control portion 5b executes the pop-down process and displays the key input screen X3 and the notification mark G12 on the display portion 3b (see FIG. 10).

For example, the UI control portion 5b causes the display portion 3b to display the key input screen X3 over a part of the menu screen X1 (see FIG. 10). The UI control portion 5b may cause the display portion 3b to display the key input screen X3 instead of the menu screen X1.

In the example shown in FIG. 10, the UI control portion 5b includes the notification mark G12 in a part of the key input screen X3. In a case where the key input screen X3 is displayed over a part of the menu screen X1, the UI control portion 5b may include the notification mark G12 in a part of the menu screen X1.

In the following description, the state in which the key input screen X3 and the notification mark G12 are displayed on the display portion 3b will be referred to as a second mark display state (see FIG. 10). After executing the process of step S302, the UI control portion 5b executes the process of step S304.

### <Step S303>

In step S303, the UI control portion 5b causes the display portion 3b to display the key input screen X3 (see FIG. 9).

For example, the UI control portion 5b causes the display portion 3b to display the key input screen X3 over a part of the menu screen X1 (see FIG. 9). The UI control portion 5b may cause the display portion 3b to display the key input screen X3 instead of the menu screen X1.

After executing the process of step S303, the UI control portion 5b executes the process of step S304.

### <Step S304>

In step S304, the UI control portion 5b checks the status of the operation on the operation portion 3a. Furthermore, the UI control portion 5b selects the next process to be executed depending on the status of the operation on the operation portion 3a.

When a character input operation on the operation portion 3a is detected, the UI control portion 5b executes the process of step S305. The character input operation is a touch operation on a character key on the virtual keyboard G20.

When the confirmation operation on the operation unit 3a is detected, the UI control portion 5b executes the process of step S306.

When the input cancellation operation on the operation portion 3a is detected, the UI control portion 5b executes the process of step S307.

When no operation on the operation portion 3a is detected, the UI control portion 5b executes the process of step S310.

### <Step S305>

In step S305, the UI control portion 5b updates the text display in the text frame G21 according to the content of the character input operation. The UI control portion 5b executes the process of step S305 every time a touch operation is performed on one key of the virtual keyboard G20.

After executing the process of step S305, the UI control portion 5b executes the process of step S304 again.

### <Step S306>

In step S306, the UI control portion 5b determines the text displayed in the text frame G21 of the virtual keyboard G20 as the text data, and sets the text data as the value of the processing parameter corresponding to the key input icon G3.

After executing the process of step S306, the UI control portion 5b executes the process of step S307.

### <Step S307>

In step S307, the UI control portion 5b selects a process to be executed depending on whether or not the state of the display portion 3b is the second mark display state.

The UI control portion 5b executes the process of step S308 in a case where the state of the display portion 3b is the second mark display state. On the other hand, in a case where the state of the display portion 3b is not the second mark display state, the UI control portion 5b executes the process of step S309.

### <Step S308>

In step S308, the UI control portion 5b closes the notification mark G12 and the key input screen X3, and causes the display portion 3b to display the menu screen X1 and the pop-up screen X2 (see FIG. 7).

After executing the process of step S308, the UI control portion 5b ends the key input control.

### <Step S309>

In step S309, the UI control portion 5b closes the key input screen X3 and causes the display portion 3b to display the menu screen X1 (see FIG. 6).

After executing the process of step S309, the UI control portion 5b ends the key input control.

### <Step S310>

In step S310, the UI control portion 5b executes mark display control to be described later. After executing the process of step S310, the UI control portion 5b executes the process of step S304 again.

### [Mark Display Control]

Next, an example of the key input control procedure executed in step S310 will be described with reference to the flowchart shown in FIG. 5.

In the following description, S401, S402, and so on represent identification codes of a plurality of steps in the mark display control. In the mark display control, first, the process of step S401 is executed.

### <Step S401>

In step S401, the UI control portion 5b selects a process to be executed depending on whether or not the notification event has occurred.

The UI control portion 5b executes the process of step S402 in a case where the notification event has occurred. On the other hand, the UI control portion 5b executes the process of step S403 in a case where the notification event has not occurred.

### <Step S402>

In step S402, the UI control portion 5b displays the notification mark G12 in a partial area of the key input screen X3 or the menu screen X1 (see FIG. 10).

After executing the process of step S402, the UI control portion 5b ends the mark display control.

### <Step S403>

In step S403, the UI control portion 5b selects a process to be executed depending on whether or not the state of the display portion 3b is the second mark display state.

The UI control portion 5b executes the process of step S404 in a case where the state of the display portion 3b is the second mark display state. On the other hand, the UI control portion 5b ends the mark display control when the state of the display portion 3b is not the second mark display state.

### <Step S404>

In step S404, the UI control portion 5b selects a process to be executed depending on whether or not the notification event has ended.

The UI control portion 5b executes the process of step S405 in a case where the notification event has ended. On the other hand, the UI control portion 5b ends the mark display control in a case where the notification event has not ended.

### <Step S405>

In step S405, the UI control portion 5b clears the notification mark G12 from the display portion 3b (see FIG. 9).

After executing the process of step S405, the UI control portion 5b ends the mark display control.

The notification mark G12 when the display portion 3b is in the second mark display state may be an operation icon that receives the pop-up operation.

For example, when the pop-up operation is detected in a situation where the display portion 3b is in the second mark display state, the UI control portion 5b closes the notification mark G12 and causes the display portion 3b to display the pop-up screen X2 (not shown).

As described above, in the pop-up state, when a touch operation is detected on the transition icon G1, the execution icon G4, or the cancellation icon G5, which are part of the plurality of operation icons G1 to G5 on the menu screen X1, the UI control portion 5b executes the process of step S101.

In step S101 in the pop-up state, the UI control portion 5b causes the display portion 3b to display a new menu screen X1 corresponding to the operation icons G1, G4, and G5 in place of the original menu screen X1 while maintaining the display of the pop-up screen X2.

The transition icon G1, execution icon G4, and cancellation icon G5 are each examples of transition operation images. The menu screen X1 newly displayed in step S101 is an example of a transition destination screen.

On the other hand, in the pop-up state, when a touch operation on the key input icon G3, which is a part of the plurality of operation icons G1 to G5 on the menu screen X1, is detected, the UI control portion 5b executes the process of step S302.

In step S302 in the pop-up state, the UI control portion 5b closes the pop-up screen X2 and causes the display portion 3b to display the key input screen X3 for the key input icon G3 (see FIG. 10).

In step S302, the UI control portion 5b causes the display portion 3b to display the key input screen X3 instead of the original menu screen X1 or over a part of the area of the original menu screen X1.

The key input icon G3 is an example of a specific operation image. The key input screen X3 is an example of a specific screen corresponding to the specific operation image.

The UI control portion 5b includes the notification mark G12 in a part of the key input screen X3 or the menu screen X1 when transitioning the display state of the display portion 3b from the pop-up state to the state in which the key input screen X3 is displayed (see step S302, FIG. 10).

In addition, when a touch operation on the confirmation icon G22 or the input cancellation icon G23 on the key input screen X3 is detected, the UI control portion 5b returns the display state of the display portion 3b to the pop-up state (see step S308).

In the present embodiment, the menu screen X1 is displayed on the display portion 3b in response to the operation of the transition icon G1, the execution icon G4, or the cancellation icon G5 (see steps S101, S102, and S105 in FIG. 2). The menu screen X1 displayed in this manner is a screen that is not intended to return to the original screen.

Therefore, in a case where the pop-up screen X2 is closed when the new menu screen X1 is displayed, there is a possibility that the pop-up screen X2 will be closed before the notification information G10 is confirmed by the user.

Therefore, when causing the display portion 3b to display the new menu screen X1, the UI control portion 5b maintains the display of the pop-up screen X2 until a touch operation on the reduction icon G11 is detected (steps S101 to S103 and S105 in FIG. 2).

On the other hand, the key input screen X3 is a screen that is temporarily displayed until the operation corresponding to the key input screen X3 is completed. In other words, the key input screen X3 is an example of a screen that is displayed on the premise of returning to the original menu screen X1.

Therefore, even when the pop-up screen X2 is closed when the key input screen X3 is displayed, the display state of the display portion 3b is returned to the pop-up state, thereby preventing the user from failing to confirm the notification information G10.

By executing the screen output control, in a case where a new screen is displayed by an operation on the menu screen X1 in the pop-up state, the pop-up screen X2 is closed with as few operations as possible while avoiding failure to confirm the notification information G10.

### Application Example

The processing of the UI control portion 5b regarding displaying and closing the key input screen X3 and the pop-up screen X2 corresponding to the key input screen X3 may be applied to other screens based on the premise of returning to the original menu screen X1.

### SUPPLEMENTARY NOTES OF THE DISCLOSURE

Hereinafter, a summary of the disclosure extracted from the above-described embodiments will be added. Note that each configuration and each processing function described in the following supplementary notes may be selected and combined as desired.

### Supplementary Note 1

A screen control method for controlling a display screen of a touch panel unit,
the screen control method including:
a processor causing the touch panel unit to display an original screen including a plurality of operation images, each of which receives a touch operation;
the processor causing a pop-up screen including notification information to be displayed over a part of the original screen when a notification event occurs while the original screen is being displayed on the touch panel unit;
the processor, when a touch operation on a transition operation image that is a part of the plurality of operation images on the original screen is detected in a pop-up state where the original screen and the pop-up screen are displayed on the touch panel unit, causing the touch panel unit to display a transition destination screen corresponding to the transition operation image in place of the original screen while maintaining the display of the pop-up screen;
the processor, when a touch operation on a specific operation image that is part of the plurality of operation images on the original screen is detected in the pop-up state, closing the pop-up screen and causing the touch panel unit to display a specific screen corresponding to the specific operation image in place of the original screen or over a part of the original screen; and
the processor returning a display state of the touch panel unit to the pop-up state when a specific screen end event indicating an end of a process corresponding to the specific screen occurs.

### Supplementary Note 2

The screen control method according to Supplementary Note 1, wherein
the specific screen is a key input screen that includes a virtual keyboard and a text frame in which text input by operating the virtual keyboard is displayed.

### Supplementary Note 3

The screen control method according to Supplementary Note 1 or 2, further including
the processor including, in the specific screen, a specific end image configured to receive an operation to instruct an end of a specific operation corresponding to the specific screen; wherein
the specific screen end event includes a detection event of a touch operation on the specific end image.

### Supplementary Note 4

The screen control method according any one of Supplementary Notes 1 to 3, further including
the processor including a simple notification image smaller than the pop-up screen in a part of the specific screen or the original screen when transitioning a display state of the touch panel unit from the pop-up state to a state in which the specific screen is displayed.

### Supplementary Note 5

A user interface device including:
a touch panel unit; and
a processor configured to implement a screen control method according to any one of Supplementary Notes 1 to 4.

### Supplementary Note 6

An image processing apparatus including:
the user interface device according to Supplementary Note 5; and
an image processing portion configured to execute image processing set by operations on the user interface device.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A screen control method for controlling a display screen of a touch panel unit,
the screen control method comprising:
a processor causing the touch panel unit to display an original screen including a plurality of operation images, each of which receives a touch operation;
the processor causing a pop-up screen including notification information to be displayed over a part of the original screen when a notification event occurs while the original screen is being displayed on the touch panel unit;
the processor, when a touch operation on a transition operation image that is a part of the plurality of operation images on the original screen is detected in a pop-up state where the original screen and the pop-up screen are displayed on the touch panel unit, causing the touch panel unit to display a transition destination screen corresponding to the transition operation image in place of the original screen while maintaining the display of the pop-up screen;
the processor, when a touch operation on a specific operation image that is part of the plurality of operation images on the original screen is detected in the pop-up state, closing the pop-up screen and causing the touch panel unit to display a specific screen corresponding to the specific operation image in place of the original screen or over a part of the original screen; and
the processor returning a display state of the touch panel unit to the pop-up state when a specific screen end event indicating an end of a process corresponding to the specific screen occurs.

2. The screen control method according to claim 1, further comprising
the specific screen is a key input screen that includes a virtual keyboard and a text frame in which text input by operating the virtual keyboard is displayed.

3. The screen control method according to claim 1, further comprising
the processor including, in the specific screen, a specific end image configured to receive an operation to instruct an end of a specific operation corresponding to the specific screen; wherein
the specific screen end event includes a detection event of a touch operation on the specific end image.

4. The screen control method according to claim 1, further comprising
the processor including a simple notification image smaller than the pop-up screen in a part of the specific screen or the original screen when transitioning a display state of the touch panel unit from the pop-up state to a state in which the specific screen is displayed.

5. A user interface device comprising:
a touch panel unit; and
a processor configured to implement a screen control method according to claim 1.

6. An image processing apparatus comprising:
the user interface device according to claim 5; and
an image processing portion configured to execute image processing set by operations on the user interface device.
